(19) United States
(12) Patent Application Publication
(10) Pub. No.: US 2008/0310298 A1
(43) Pub. Date: Dec. 18, 2008

(54) Providing Bypass Switches to Bypass Faulty Nodes

(76) Inventor: Geir Andre Motzfeldt Drange, Asker (NO)

Correspondence Address: WesternGeco L.L.C.;Jeffrey E. Griffin, 10001 Richmond Avenue, HOUSTON, TX, 77042-4299, US

(21) Appl. No.: 11/764,056

(22) Filed: Jun. 15, 2007

(51) Int. Cl. G06F 11/00

(52) U.S. Cl. 370/217

(57) ABSTRACT

A streamer or cable for use in subterranean surveying includes a communications link, a plurality of network nodes interconnected by the communications link, where each of the plurality of network nodes is configured to perform a self-test to detect a fault condition of the corresponding network node, and bypass switches to bypass faulty one or more network nodes.

### TECHNICAL FIELD

The invention relates generally to providing bypass switches to bypass faulty one or more nodes in a streamer.

### BACKGROUND

A marine seismic streamer is an elongate cable-like structure, which can be several thousands of meters long. The streamer includes arrays of acoustic sensors (e.g., geophones or hydrophones) and associated electronic equipment along the length of the streamer. The acoustic sensors are used to perform marine seismic surveying.

Typically, a number of streamers are towed by a sea vessel to perform a marine seismic survey. The streamers are deployed from a sea vessel, typically from the aft of the sea vessel. Each streamer is unwound from a reel or spool for deployment into the water.

The electronic devices (including sensors and other devices) in a streamer are associated with network nodes that are interconnected by one or more communications links in the streamer. The network nodes include telemetry modules to perform communications over the one or more communications links.

In the relatively harsh marine environment, there is some likelihood that network nodes in the streamer can malfunction. Conventionally, if a network node malfunctions, that may cause the entire streamer to malfunction, depending on the type of fault in the faulty network node. Thus, if the faulty network node were to cause the entire streamer to malfunction, then the entire streamer is rendered useless, which would require that the streamer be retrieved from the body of water to replace the faulty network node. Such a procedure is time consuming and costly.

### SUMMARY

In general, according to an embodiment, a streamer comprises a communications link and a plurality of network nodes interconnected by the communications link. Each of the plurality of network nodes is configured to perform a self-test to detect a faulty condition of the corresponding network node. Bypass switches are provided to allow faulty one or more network nodes to be bypassed.

In general, according to another embodiment, a system includes a controller and a cable having a network including at least one communications link connected to the controller. The cable further includes network nodes interconnected by the at least one communications link, where the network nodes enable subterranean surveying and are configured to perform a self-test to detect for a faulty condition. The cable further includes bypass switches to bypass faulty one or more network nodes from the at least one communications link.

Other or alternative features will become apparent from the following description, from the drawings, and from the claims.

### BRIEF DESCRIPTION OF THE DRAWINGS

FIG. 1 illustrates a sea vessel that is able to deploy a streamer in a body of water, according to an example.

FIG. 2 illustrates a portion of an example network of a streamer, where the network includes network nodes having bypass switches according to an embodiment.

FIG. 3 is a block diagram of a portion of another example network of a streamer, where the network nodes include bypass switches according to some embodiments.

FIG. 4 is a block diagram of a network node according to an example embodiment.

FIG. 5 is a flow diagram of a process performed by a network node, according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

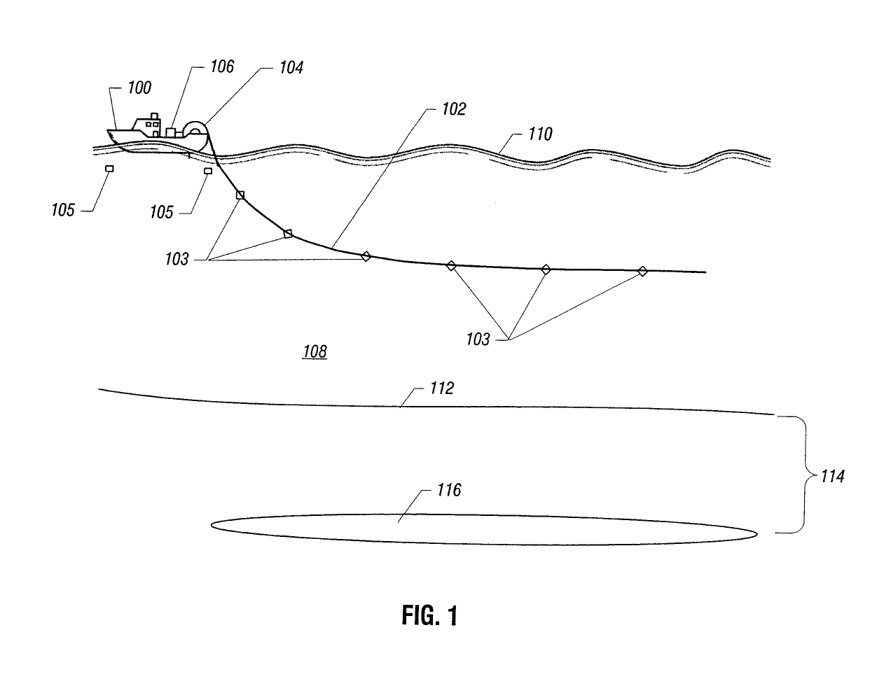

FIG. 1 illustrates a sea vessel 100 that has a reel or spool 104 for deploying a streamer 102 (or multiple streamers 102), where the streamer 102 is a cable-like structure having a number of electronic devices 103 for performing a subterranean survey of a subterranean structure 114 below a sea floor 112. In the following, the term “streamer” is intended to cover either a streamer that is towed by a sea vessel or a seabed cable laid on the sea floor 112.

The electronic devices 103 can include sensors, steering or navigation devices, air gun controllers (or other signal source controllers), positioning devices (e.g., acoustic positioning devices), and/or other devices. A portion of the streamer 102 is deployed in a body of water 108 underneath a sea surface 110.

Also depicted in FIG. 1 are a number of signal sources 105 that produce signals propagated into the body of water 108 and into the subterranean structure 114. The signals are reflected from layers in the subterranean structure 114, including a resistive body 116 that can be any one of a hydrocarbon-containing reservoir, a fresh water aquifer, an injection zone, and so forth. Signals reflected from the resistive body 116 are propagated upwardly toward the sensors of the streamer 102 for detection by the sensors. Measurement data is collected by the sensors, which can store the measurement data and/or transmit the measurement data back to a control system (or controller) 106 on the sea vessel 100.

Although the sources 105 are depicted as being separate from the streamer 102, the sources 105 can also be part of the streamer 102 in a different implementation.

The sensors of the streamer 102 can be seismic sensors, which are implemented with acoustic sensors such as hydrophones or geophones. The signal sources 105 can be seismic sources, such as air guns or explosives. In an alternative implementation, the sensors can be electromagnetic (EM) sensors, and the signal sources 105 can be EM sources that generate EM waves that are propagated into the subterranean structure 114.

The various electronic devices 103 of the streamer 102 are either part of or are coupled to network nodes that are part of a network in the streamer 102. The network in the streamer 102 includes one or more communications links that interconnect the network nodes, where the network nodes include telemetry modules to allow for communication over the one or more communication links. The network nodes of the streamer 102 are able to communicate over the network to the control system 106 provided on the sea vessel 100. For example, the network nodes are able to communicate measurement data collected by sensors over the network to the control system 106 for processing. Also, the control system 106 is able to send commands to various electronic devices, such as steering or navigation devices, air gun controllers, acoustic positioning devices, and other devices, to perform predefined tasks (such as steering to laterally position the streamer 102, activation of air guns to produce source seismic signals, activation of acoustic positioning devices to detect a position of the streamer, and so forth).

Generally, a network node refers to any device that can perform communications over the network of the streamer 102. The network nodes can be addressed by the control system 106, such as by use of command packets. Also, data packets can be communicated between the network nodes and the control system 106 to carry measurement data or other data.

Although reference is made to streamers in this discussion, it is noted that mechanisms and techniques according to some embodiments can be used with land-based cables for performing seismic or EM surveying as well.

An issue associated with a network provided in the streamer 102 is that one or more network nodes may malfunction during a survey operation. It is desirable to be able to continue the survey operation even though one or more network nodes have malfunctioned. To enable the continued operation of the streamer 102 in this scenario, the faulty network node(s) can be bypassed. In some embodiments, bypassing of network nodes is accomplished by using bypass switches provided with the network nodes, where the bypass switches are controllable by the network nodes themselves or by the control system 106.

A feature of a network node according to some embodiments is that the network node is able to perform a self-test procedure when the network node powers up from an off state or powers up from a sleep state (which is a reduced power state as compared to a completely on state). If the network node detects, as a result of the self-test procedure, that it has experienced a fault condition that would render it inoperable in the streamer 102, then the network node can either set its respective bypass switch to bypass the faulty network node, or alternatively, the network node can send some type of a failure indication to the control system 106 such that the control system 106 can send a command to the respective bypass switch to bypass the faulty network node.

Note that a “bypass switch” can include one or more switching devices, including electrical switching devices and/or optical switching devices.

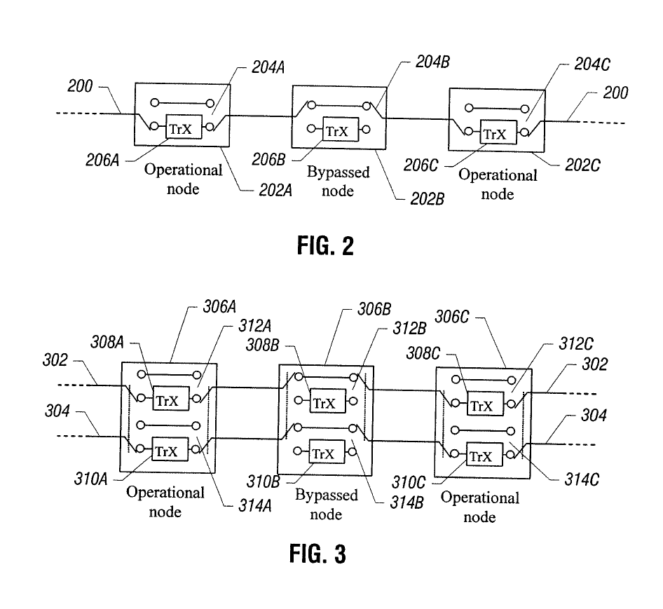

FIG. 2 shows a portion of a network in a streamer according to an embodiment. The portion of the streamer network depicted in FIG. 2 includes network nodes 202A, 202B, and 202C, which contain respective transceivers 206A, 206B, and 206C. The transceivers 206A, 206B, and 206C are able to transmit and/or receive data (and/or commands) over a communications link 200 of the streamer network.

The transceivers 206A, 206B, and 206C can be either electrical transceivers or optical transceivers. Electrical transceivers are able to communicate data over an electrical communications link, whereas an optical transceiver is able to communicate optical signals over an optical link. Thus, in some embodiments, the communications link 200 of the streamer network can either be an electrical link or an optical link (or both).

Each of the network nodes 202A, 202B, and 202C further includes a respective bypass switch 204A, 204B, and 204C (which can be electrical switches or optical switches). Each bypass switch 204 can be set to a first (bypass) position to bypass the respective transceiver 206, or to a second (connected) position to connect the respective transceiver 206 to the communications link 200. In the example of FIG. 2, the bypass switch 204A is set to the connected position to connect the transceiver 206A of network node 202A to the communications link 200. Similarly, the bypass switch 204C of the network node 202C is set to the connected position to connect the transceiver 206C to the communications link 200. However, the bypass switch 204B of the network node 202B is set to the bypass position to bypass the respective transceiver 206B (in other words, the network node 204B is electrically isolated from the communications link 200).

Each network node can include control logic to control the position of the bypass switch 204. Alternatively, setting of the bypass switch 204 in a network node 202 between different positions can be accomplished using a remote command sent from the control system 106 (FIG. 1).

In the example depicted in FIG. 2, the network node 202B is considered a faulty network node that has been bypassed from the communications link 200 such that the faulty network node 202B does not interfere with communications of other operational network nodes (including network nodes 202A, 202C in FIG. 2).

In operation, when the streamer 102 is initially deployed and the network nodes are in a power off or sleep state, the bypass switches 204 are set in their respective bypass positions (to isolate corresponding network nodes from the communications link 200). Once power is supplied to a respective network node, the network node performs a self-test procedure. Note that the streamer has multiple sections that can be powered on sequentially one at a time.

If the network node 202 detects that it is operational, then the network node can set the corresponding bypass switch 204 to the connected position to connect the transceiver 206 of the network node 202 to the communications link 200. However, if the network node detects a malfunction, then the network node sets the corresponding bypass switch 204 to the bypass position to isolate the network node from the communications link 200. Instead of the network node setting the position of the corresponding bypass switch, it is noted that the network node can alternatively send indications to the control system 106 (FIG. 1) regarding whether the network node has passed or failed the self-test procedure. The control system 106 can then send the appropriate commands to set the bypass switch to the bypass or connected position.

Note that although reference is made to setting the position of one bypass switch to bypass or connect a network node to the communications link 200, it is noted that in other implementations, multiple bypass switches are set to perform the bypassing or connection.

FIG. 3 shows a different embodiment of a streamer network. In the FIG. 3 embodiment, two communications links 302 and 304 are used to interconnect network nodes 306A, 306B, and 306C. Each network node 306A, 306B, 306C has a respective pair of transceivers 308 and 310 (pair 308A, 310A in network node 306A, pair 308B, 310B in network node 306B, and pair 308C, 310C in network node 306C). The transceivers 308A-308C are used to communicate over communications link 302, whereas the transceivers 310A-310C are used to communicate over the communications link 304. In alternative implementations, additional communications links can be used in the streamer network.

As further depicted in FIG. 3, each network node also includes a corresponding pair of bypass switches 312 and 314 (312A, 314A in network node 306A, 312B, 314B in network node 306B, and 312C, 314C in network node 306C).

In the example arrangement of FIG. 3, the network node 306B is a bypassed node, whereas the network nodes 306A, 306C are operational nodes that are connected to the communications links 302, 304.

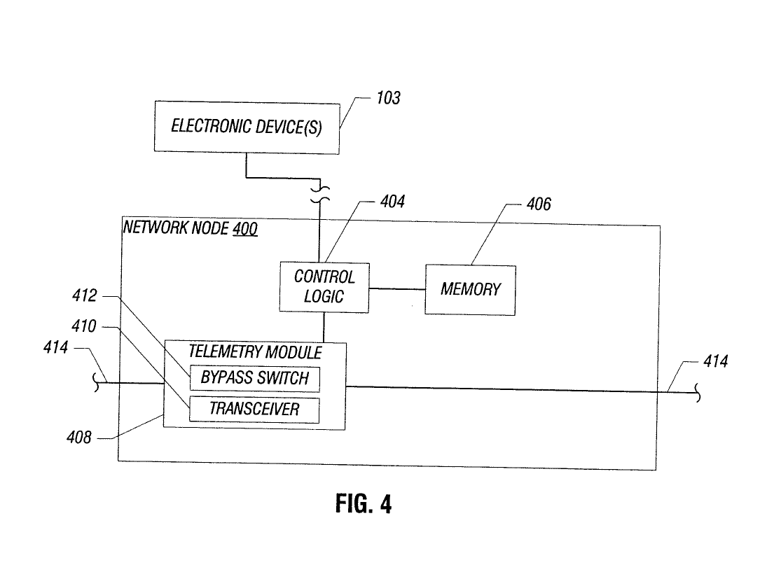

FIG. 4 shows an example block diagram of a network node 400 that is coupled to an electronic device 103 (or multiple electronic devices 103). In an alternative implementation, the network node 400 can be part of the electronic device 103. The network node 400 can be either the network node 202 of FIG. 2 or the network node 306 of FIG. 3. Examples of the electronic device(s) 103 include a sensor, a steering or navigation device, a signal source controller, a positioning device, and so forth.

The network node 400 includes control logic 404 and memory 406. The control logic 404 can be implemented with a microcontroller or microprocessor. The control logic 404 is connected to a telemetry module 408 in the network node 400, where the telemetry module 408 includes a transceiver 410 (any of the transceivers 206, 308, and 310 depicted in FIGS. 2 and 3) and a bypass switch 412 (any of the bypass switches 204, 312, and 314 depicted in FIGS. 2 and 3). The telemetry module 408 allows the network node 400 to communicate over a communications link 414 (any of communications links 200, 302, and 304 in FIGS. 2 and 3) if the bypass switch 412 is set to the connected position to connect the transceiver 410 to the communications link 414. However, if the bypass switch 412 is set to the bypass position to bypass the transceiver 410, then the network node 400 is electrically isolated from the communications link 414.

The control logic 404 can perform the self-test procedure discussed above. Also, the control logic 404 is able to communicate with the control system 106 (FIG. 1) on the sea vessel 100.

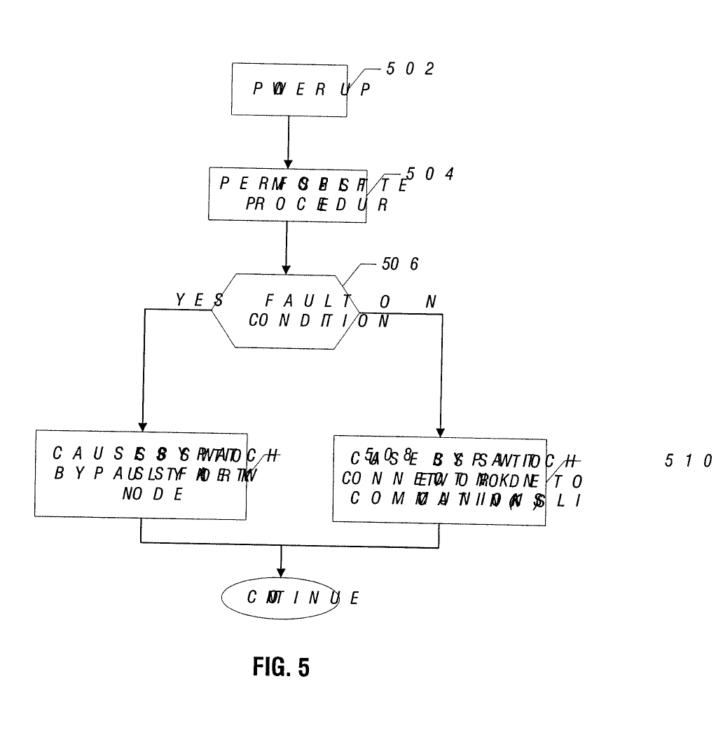

FIG. 5 shows a flow diagram of a process performed by a network node, in accordance with an embodiment. The network node first powers up (at 502) from either an off state or a sleep state. As part of the power-up procedure, the network node performs (at 504) a self-test procedure to test the network node for a fault condition. If a fault condition is detected (at 506), then the network node causes (at 508) the bypass switch of the network node to bypass the network node. The network node is able to cause the bypass switch to perform this bypass by either using the control logic 404 (FIG. 4) to directly control the setting of the bypass switch 412, or to send some indication over the communications link 414 to the remote control system 106 (FIG. 1). In response to this indication, the remote control system 106 is able to send a command to the network node 400 to cause the bypass switch 412 to be set to bypass the network node.

If a fault condition is not detected (at 506), then the network node causes (at 510) the bypass switch to be set to a connected position to connect the network node to the communications link.

By using the bypass switches according to some embodiments in combination with the ability of network nodes to perform self-test procedures, a technique and mechanism is provided to allow faulty network nodes to be bypassed such that the rest of the streamer network can still continue to operate. As faulty network nodes can be bypassed, an operator would not have to retrieve a streamer from the water for the purpose of repairing or replacing the faulty network node(s), which can be a time-consuming and labor-intensive process.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A streamer for use in a marine survey, comprising:
a communications link;
a plurality of network nodes interconnected by the communications link, wherein each of the plurality of network nodes is configured to perform a self-test to detect a fault condition of the corresponding network node; and
bypass switches to bypass faulty one or more network nodes.

2. The streamer of claim 1, wherein the bypass switches comprise electrical switches.

3. The streamer of claim 1, wherein the bypass switches comprise optical switches.

4. The streamer of claim 1, wherein the communications link comprises at least one of an electrical link and an optical link.

5. The streamer of claim 1, wherein each of the plurality of network nodes includes control logic to control a setting of the corresponding bypass switch.

6. The streamer of claim 5, wherein if the control logic detects the fault condition in the self-test, then the control logic is configured to set the corresponding bypass switch to a position to cause the corresponding network node to be electrically isolated from the communications link.

7. The streamer of claim 1, wherein each network node includes a transceiver, and wherein the corresponding bypass switch is settable to a first position to bypass the transceiver and to a second position to connect the transceiver to the communications link.

8. The streamer of claim 1, further comprising electronic devices coupled to the network nodes.

9. The streamer of claim 8, wherein the electronic devices include at least one of sensors, steering devices, signal source controllers, and positioning devices.

10. The streamer of claim 1, further comprising:
at least a second communications link to interconnect the plurality of network nodes; and
a second set of bypass switches to bypass faulty one or more network nodes from the second communications link.

11. The streamer of claim 1, wherein each of the plurality of network nodes is configured to perform the self-test in response to the network node powering up from one of an off state and a sleep state.

12. The streamer of claim 1, wherein each network node is configured to communicate an indication of the fault condition to a remote control system over the communications link, and to receive a command from the remote control system to set a position of the corresponding bypass switch.

13. A method of performing a marine survey comprising:
deploying a streamer into a body of water, wherein the streamer includes a network having a communications link and a plurality of network nodes interconnected by the communications link;
performing a self-test in each of the plurality of network nodes to detect a fault condition of the corresponding node; and
set one or more bypass switches to bypass faulty one or more network nodes.

14. The method of claim 13, wherein performing the self-test in each of the plurality of network nodes is in response to the corresponding network node powering up from one of an off state and a sleep state.

15. The method of claim 13, further comprising setting the bypass switches to bypass all network nodes in the streamer when the network nodes are in one of an off state and a sleep state, and setting one or more bypass switches to connect corresponding network nodes to the communications link in response to the self-test indicating that the corresponding network nodes are operational.

16. The method of claim 15, further comprising performing a survey operation using the operational network nodes with the faulty one or more network nodes bypassed.

17. The method of claim 13, further comprising performing a survey operation with electronic devices associated with the network nodes, wherein the electronic devices include at least one of sensors, steering devices, signal source controllers, and positioning devices.

18. A system comprising:
a controller; and
a cable having a network including at least one communications link connected to the controller, wherein the cable further includes network nodes interconnected by the at least one communications link, wherein the network nodes enable subterranean surveying and are configured to perform a self-test to detect for a faulty condition, and
wherein the cable further includes bypass switches to bypass faulty one or more network nodes from the at least one communications link.

19. The system of claim 18, wherein the cable comprises a streamer, and the streamer includes electronic devices associated with the network nodes, wherein the electronic devices include at least one of sensors, steering devices, signal source controllers, and positioning devices.

20. The system of claim 18, wherein the bypass switches comprise optical switches.

21. The system of claim 18, wherein the bypass switches comprise electrical switches.

22. A cable for use in performing a seismic survey, comprising:
a communications link;
a plurality of network nodes interconnected by the communications link to enable performance of the seismic survey, wherein each of the plurality of network nodes is configured to perform a self-test to detect a fault condition of the corresponding network node; and
bypass switches to bypass faulty one or more network nodes.

23. The cable of claim 22, wherein each of the plurality of network nodes includes control logic to control a setting of the corresponding bypass switch.

24. The cable of claim 23, wherein if the control logic detects the fault condition in the self-test, then the control logic is configured to set the corresponding bypass switch to a position to cause the corresponding network node to be electrically isolated from the communications link.

25. The cable of claim 22, further comprising seismic sensors coupled to the network nodes.
